(19) United States
(12) Patent Application Publication
(10) Pub. No.: US 2005/0213599 A1
(43) Pub. Date: Sep. 29, 2005

(54) Distributed LAN bridging system and process

(76) Inventor: Michael G. Clawson, Germantown, MD (US)

Correspondence Address: Karambelas & Associates;Suite 303, 655 Deep Valley Drive, Rolling Hills Estates, CA, 90274, US

(21) Appl. No.: 10/977,033

(22) Filed: Oct. 29, 2004

Related U.S. Application Data
(60) Provisional application No. 60/516,615, filed on Oct. 30, 2003.

(51) Int. Cl. H04J 3/16

(52) U.S. Cl. 370/437

(57) ABSTRACT

A distributed LAN bridging system and method for use with an IP network. A wide area network (WAN), or public network, such as the Internet, including a DVB-RCS satellite network, is used to transport encapsulated private data between distributed local area networks (LANs). In an exemplary embodiment, a source local area network (LAN) is coupled by way of a data encapsulating device to the WAN. The data encapsulating device is used to encapsulate data derived from the source LAN. A destination local area network (LAN) is coupled by way of a de-encapsulating device to the WAN. The de-encapsulating device is used to de-encapsulate data transmitted over the WAN. The distributed LAN bridging system and method captures and encapsulates LAN traffic (data), transports this traffic over a WAN, and de-encapsulates and transmits such de-encapsulated data to another LAN, and wherein the LANs are connectable at any point in the IP network. Distributed LAN bridging processes are also disclosed.

### BACKGROUND

I. Field of Invention

This present invention relates in general to telecommunication equipment and local area networks (LANs) and more particularly to a distributed LAN bridging network, which provides a system to connect or bridge LANs across an arbitrary network allowing the bridged networks to be located virtually anywhere.

II. Prior Art

The wide spread use and advancement of telecommunications equipment has facilitated the dispersal of information of all types including personal, business, governmental, and educational, etc. It is without question that there is a significant benefit to society when information of all types is readily available. For many decades public and institutional libraries have been made available to provide access to vast volumes of information, but these have proven to be burdensome and time-consuming in providing such information.

In recent years the Internet has become immensely popular and enjoyed a great deal of success primarily due to its ease of access and ability to provide new and updated information and data almost simultaneously with provision of such data to the network. This coupled with the abundance of home and office computers and the proliferation of Internet service providers has resulted in enormous amounts of information available to a user at either home or office employing a computer. A user connected to the Internet, for example via a telephone line modem, and service provider can browse through the various Internet databases generally at only the cost of a connection to the Internet service.

The Internet architecture includes a government-installed network, termed the “backbone”, to which many governmental and educational institutions are directly connected. Accordingly, a vast amount of data and information is easily distributed throughout government and educational institutions by large mainframe computer databases, without involving private or public telephone companies. In order for individuals and businesses other than those with Internet mainframe computers to be connected to the “backbone” many service providers, i.e., web sites, have become available.

Communications services offered to customers can fall broadly into two categories: public and private. Many attempts have been made to efficiently provide both of these services to customers over a common networking infrastructure.

The dominant protocol for network communications is “Internet Protocol”, most often called “TCP/IP”, hereinafter referred to as “IP”. IP was borne from the need to connect many LANs to one another so that they could communicate with one another. IP allows the creation of inter-networks or “Internets” by connecting LANs together via wide area networks (WANs). The largest of all of these networks or internets is known as the Internet. In an IP network each device is assigned a number called an “IP address”. In order for every device with every other device, every IP address must be unique. This is true in the Internet, but for other networks it may not be necessary to have global connectivity and since the threat of hacking exists, it is often desirable to isolate one's network from the rest of the world.

Public service can be defined simply as providing connectivity to the global Internet. Of course, all IP addresses on the Internet are globally-unique. On the other hand, services supporting a private network should allow customers to use whatever IP address he or she wishes, whether or not the addresses are in use in some other network. Moreover, the private network may have the additional requirement that it is isolated from other networks even if there is overlap in the addresses. Since the requirements of public and private networking are somewhat contradictory, a number of technical problems can occur when trying to integrate them on the same infrastructure.

Generally there are two ways to deal with competing public and private networks in a shared infrastructure. One, for example, may be by connecting networks using WAN technologies such as ATM and frame-relay that operate independently from IP. ATM (asynchronous transfer mode) technology is a network technology based on transferring data in cells or packets having a fixed size, while frame-relay technology is a packet switching protocol for connecting devices on a wide area network (WAN). These technologies are essentially not effected with what the network traffic carries so that the IP addresses in use are irrelevant. The second method known to those skilled in the art is to encapsulate the data from a secondary network employing technologies such as LAN emulation (LANE), Ethernet Over IP (EOIP), Generic Routing Encapsulation (GRE), or multi-protocol label switching (MPLS) so that the data can be transported through some other primary network.

One of the preferred current satellite-based technologies for networking on a large scale is DVB-RCS. DVB or digital video broadcasting is designed primarily with video in mind, but is also intended to be sufficiently general so as to allow for the delivery of other digital programs. DVB is broadcast from one point to many and does not provide for data traveling in the opposite direction. RCS, or return channel via satellite, satisfies that need so that DVB-RCS provides a network topology that has one large data pipe broadcast from one site to many receivers and another data pipe shared by many receivers received at one site, usually referred to as hub-spoke technology.

It would appear in the prior art, that without re-engineering the satellite equipment, the solution of fully integrating private networking with gear designed primarily to support the public Internet in the context of DVB-RCS would require some form of encapsulation of the private data to be transmitted through the otherwise public IP network.

Various systems have attempted to supply efficient LAN bridging or bridging between LANs in the prior art.

In U.S. Pat. No. 6,553,029 there is described a link aggregation in Ethernet frame switches comprising data packets containing source and destination addresses which are received on one or more incoming ports for distribution on one or more outgoing ports. An address look-up table stores previously processed source and destination addresses, together with source and destination contexts associated with the respective source and destination addresses. The contexts represent either a specific physical port, or an aggregated grouping of ports. A distribution table stores, for each aggregated grouping of outgoing ports, a corresponding aggregated group of identifiers of specific outgoing ports. As each packet is received, its source and destination addresses are extracted and the address look-up table is searched for those source and destination addresses. If the address look-up table contains those source and destination addresses then the source and destination contexts associated with those source and destination addresses are retrieved from the address look-up table. If the address look-up table does not contain a source address corresponding to the extracted source address, then a source context corresponding to the extracted source address is derived and stored in the address look-up table with the extracted source address. If the retrieved destination address context represents a specific outgoing port, then the received packet is queued for outgoing transmission on that port. If the retrieved destination address context represents an aggregated grouping of outgoing ports, then the identifiers for the outgoing ports comprising that grouping are retrieved from the distribution table, and the received packet is queued for outgoing transmission on all of the outgoing ports comprising that grouping.

In U.S. Pat. No. 6, 493,348 another distributed LAN-type system is disclosed comprising an Internet protocol based system and method which facilitates communication and improve the overall network performance between remote user terminals and Web servers across the parts of the Internet (or IP-based Intranets), that are configured by a communications network, including an asynchronous transfer mode (ATM) network. In particular, the system includes a plurality of Local Area Networks (LANs), such as Ethernet LANs, each comprising a plurality of user terminals or PCs. The system further comprises at least one network switch (such as an ATM switch), and at least one digital subscriber line (xDSL) access router, each connected between a corresponding LAN and the network switch. The xDSL access routers function both as a router and a digital subscriber line multiplexer. Thus, each user terminal communicates directly with its default router, and vice-versa, obviating the requirement of communicating via the network switch (e.g., ATM switch) to the default IP edge routers. Further, in the case where Quality of Service is required, the xDSL access router serves as the default router for the Web server, and the physical path between the Web server and the terminal can be minimized to one pass through the network switch and thereby reducing traffic through the communications network.

In U.S. Pat. No. 6, 385,203, a communication server profile information on twisted pair lines in a profile table is disclosed. This profile information may be generated in a training session and then retrieved to train a modem or transceiver unit to communicate data over the associated twisted pair line using XDSL communication techniques.

In U.S. Pat. No. 6,345,051 there is disclosed a method and apparatus for communicating to a destination node over a broadband network from plural users connected to an access node. A virtual circuit is processed through the broadband network for connecting the access node to the destination node. Data units are received from plural users at the access node, with each data unit having plural cells. The data units are multiplexed onto the virtual circuit at the access node such that the cells of any one data unit are noninterleaving with the cells of any other data unit on the virtual circuit. In a preferred embodiment, the destination node is a service provider node in an ATM network and the data units are Ethernet protocol data units that comprise plural ATM cells. According to another aspect, an access node for communicating to a service provider node over an ATM network includes at least one line unit for transmitting Ethernet protocol data units to and from plural users, each Ethernet protocol data unit comprising plural ATM cells, the line unit coupling the ATM cells to and from a communication bus. A trunk unit coupled to the communication bus transmits and receives ATM cells to and from the ATM network.

In U.S. Pat. No. 6,320,863 a backplane for a dynamic synchronous transfer mode network that comprises two dual ring topologies having opposite fiber direction is disclosed. The ring topologies have a plurality of disjointed segments that permits the simultaneous transmission of signals in the same time slots over the disjointed segments.

In U.S. Pat. No. 6,230,203 there is disclosed a system for providing flexible billing in a cable environment which can establish billing practices based on tier level of service, quality of service or the amount of network resources consumed. A plurality of tiers or levels of service can be defined by parameters including at least a maximum or peak bit rate or bandwidth for providing services over a shared channel. A plurality of levels or tiers of services are defined by maximum bandwidth or bit rate and a subscriber receives service at that subscribe-to level or at a slower data rate depending on availability of shared bandwidth. Quality of service is maintaining the specified bandwidth, jitter or delay. The amount of network resources consumed may be expressed in terms of the amount of data transmitted or the connect time of a network access device to the network.

In U.S. Pat. No. 5,910,954 there is described a network having at least one emulated local area network (LAN) therein which includes groups of legacy LAN workstations, network switches and an ATM switch. The network switches are each connectable to one of the groups of the legacy LAN workstations. The ATM switch is connectable to the network switches and each network switch includes a cell memory, a cell memory manager, local switching apparatus and remote switching apparatus. The cell memory stores cells of data. The cell memory manager converts data back and forth between a format and a cell format, stores the cell format data in the cell memory and retrieves calls therefrom. The local switching apparatus locally switches cells of data among the group of legacy LAN workstations connectable to the network switch. The remote switching apparatus switches the cells of data from the network switch to a remote network switch via the ATM switch.

In U.S. Pat. No. 5,905,781 a communication server (700) is disclosed which includes a plurality of xDSL transceiver units (710) and a plurality of line interface modules (702). Each line interface module (702) has a plurality of inputs each coupled to a twisted pair data line. Each line interface module (702) also has a plurality of outputs each associated with one of the xDSL transceiver units (710). Each line interface (702) is operable to couple a requesting twisted pair data line to an output associated with a selected xDSL transceiver unit (710). The communication server (700) also includes a network interface (714) that has a plurality of inputs coupled to associated xDSL transceiver units (710). The communication server (700) further includes a system controller (712) coupled to the xDSL transceiver units (710), to the plurality of line interface modules (702) and to the network interface (714). The system controller (712) is operable to select an available xDSL transceiver unit (710) in response to a detected request for data service and to direct the line interface module (702), to which the twisted pair data line requesting data service is coupled, to connect the requesting twisted pair data line to the selected xDSL transceiver unit (710).

In U.S. Pat. No. 5,838,682 an Internet type access system is disclosed which includes an autodialer for automatically establishing communications with a merchant's facility over a switch network while maintaining Internet connectivity over a packet data network. The autodialer, in combination with the merchant's server, coordinates between the Internet session and the newly established switched connectivity, the session history from the prior Internet session being supplied to a sales representative receiving the autodialed call. The sales representative is provided with a terminal for controlling the merchant's server to push data to the client in response to the interactive session simultaneously conducted over the switched network.

In U.S. Pat. No. 5,818,842 a computer communications network is disclosed comprising a plurality of interconnected ATM switches forming a WAN or LAN area network over which ATM cells are transmitted, and a plurality of user devices including LAN interface adapters for connection to one or more local area networks (LANs). An interface device connects at least some of the respective ATM switches to the LAN interface adapters. The interface adapts the ATM cells for transport over the LANS. The user devices can thus communicate through the LAN interface adapters transparently with the wide area network.

In U.S. Pat. No. 5,818,525 methods and systems for resource management in a fast packet switching communication network are disclosed. A packet containing an address field identifying a source endpoint and a destination endpoint is received. A bandwidth constraint based upon the source endpoint, but independent of the destination endpoint, is enforced for the packet. In a communication network wherein a plurality of virtual connections are provisioned from a single source endpoint to a plurality of destination endpoints, the bandwidth constraint is associated with bandwidth usage over all of the virtual connections.

In U.S. Pat. No. 5,790,806 there is disclosed a cable data network architecture includes a master head-end, at least one distribution hub connected to the master head end via a first communication link, and one more user modems connected to the distribution hub(s) via a second communication link. The master head end includes an inter-hub communications switch, a network controller, a network element manager, and one or more external communication links. The distribution hub includes at least one radio frequency modulators for modulating and transmitting data, at least one demodulator for receiving and demodulating return data, a link access control computer for controlling transmission and reception of data by the distribution hub, a hub element manager for detecting faulty communications to and from the distribution hub, and a local switch for switching data between the modulators, the demodulators, the link access computer and the hub element manager within the distribution hub. The user modem(s) includes a tuner for determining a channel for receiving data from the distribution hub, a demodulator for demodulating the received data, an address recognition circuit for determining whether an address associated with the data corresponds to an address served by the user modem, a modulator for modulating transmission data to be transmitted by the user modem, a tuner for determining a transmission channel for transmitting the transmission data, and a timing and control circuit for determining when the user modem transmits the transmission data to the distribution hub over the second communication link.

In U.S. Pat. No. 5,706,279 methods and systems for controlling a flow of packets being forwarded by a customer premises equipment to an endpoint of a fast packet switching network having a plurality of virtual connections provisioned from the endpoint to a plurality of destination endpoints are disclosed. A parameter indicative of bandwidth usage associated with the endpoint over at least two of the virtual connections is obtained. The flow of packets being forwarded to the endpoint is inhibited when the parameter violates a predetermined threshold.

In U.S. Pat. No. 5,692,126 a Health Care Information Network is disclosed which allows subscribers access to a data center. A LAN arranged at the data center is connected through a frame relay network to a LAN of a similar type located at a central office. ISDN/LAN bridges link the LAN to an ISDN switch that provides the subscribers with ISDN Centrex services. A PC at the subscriber's site can gain the subscriber access to the ISDN switch via an ISDN Centrex line. The subscribers are provided with voice, image and data transmission, and can communicate not only with the data center but with each other. For disaster recovery, e.g., if a connection is broken or defective, the network can provide alternative routes. A network manager at the data center is able to configure the network, monitor its status and react to failures and overloads on a real time basis.

In U.S. Pat. No. 5,623,492 methods and systems for resource management in a fast packet switching communication network are disclosed. A packet containing an address field identifying a source endpoint and a destination endpoint is received. A bandwidth constraint based upon the source endpoint, but independent of the destination endpoint, is enforced for the packet. In a communication network wherein a plurality of virtual connections are provisioned from a single source endpoint to a plurality of destination endpoints, the bandwidth constraint is associated with bandwidth usage over all of the virtual connections.

In addition to the above bridging systems, various distributed LAN systems and methods have been employed in the prior art.

In U.S. Pat. No. 6,539,011 a permanent virtual connection (PVC) is disclosed which automatically sets up over an Ethernet local area network (LAN) link between a work station device having a digital telephone and a Communications Switching Module (CSM) when the device is first connected to the LAN. The PVC is established by exchange of information in standard Ethernet packets between the device and the CSM. Automatic reservation of a full duplex PVC for digital telephone signaling and control information enables set up and break down of voice channels within the same PVC by exchange of signaling information in standard Ethernet packets.

In U.S. Pat. No. 6,466,572 a technique for multiplexing high speed computed data with digitized voice signals onto a fiber optic cable for transfer to a local central office is disclosed. The data packets of a number of computers are networked by way of a distributed hub that extends to residences, offices, apartments, etc. The data packets are switched outside the switching fabric of a local central office and routed to the Internet or elsewhere. Command signals that are for accessing the Internet are transmitted and received as 10 MHz Ethernet data packets on the distributed hub.

In U.S. Pat. No. 6,362,908 there is disclosed a multi-service, adaptable optical network unit (ONU) for use in a fiber-to-the-curb (FTTC) digital loop carrier system, including a multi-service common card and a plurality of multi-media service cards that are connected to the common card using a card-link interface. The card-link interface is preferably a high-speed LVDS serial-bus connection that is organized in a star configuration such that each service card is connected to the multi-service common card using a separate point-to-point card-link. By eliminating the traditional backplane structure found in present ONU designs, the present invention provides a scalable, adaptable, future-proof FTTC system that can transport present-day multi-media services as well as yet-to-be-defined future high-bandwidth applications.

In U.S. Pat. No. 6,215,789 an Ethernet Local Area Network using a star topology is disclosed connecting user stations to a Communications Switching Module (CSM) with 10Base-T or 100 Base-TX UTP cable. Each user station typically has a digital telephone and a data communication device, such as a PC communicating with the CSM through a common UTE adapter. Delay-sensitive digital voice signals and non-delay sensitive user data are transported in master Ethernet packets of fixed length transmitted at a fixed rate. Segmentation and re-assembly of data is performed in the UTE adapters and in the CSM.

In U.S. Pat. No. 6,061,737 there is disclosed an intermodule network bus architecture using only two bus wires to transmit data and module state information. A two-pin bus interface in each network module connected to the bus provides for a distributed arbitration procedure in the event that two or more modules are competing for bus access, and provides a coding scheme under which both data signals and collision announcements are transmitted from module to module through the two-wire bus. The architecture handles multiple distributed repeater modules, as well as other network components such as bridges and routers connected to the same bus. An important aspect of the invention is that multiple bus interfaces function as a distributed state machine, to handle the arbitration process and to provide a consistent framework for detecting and processing data signals and various types of collisions, including receive collisions detected on a single local module port, and transmit collisions involving activity on multiple local ports of one or more modules.

In U.S. Pat. No. 6,028,860 a bi-directional communications system in a CATV network utilizing cell-based Asynchronous Transfer Mode (ATM) transmissions is disclosed. Packet data existing in any one of several different formats are first converted into ATM cells by a headend controller. Individual cells are then assigned a virtual connection by the headend controller. Based on the virtual connection, the cells can be prioritized and routed to their intended destinations. The cells are transmitted in a shared radio frequency spectrum over a standard cable TV network. A subscriber terminal unit demodulates the received RF signal and processes the cells for use in a computer. Likewise, computers may transmit packet data to their respective subscriber terminal units which are sent to the headend controller over the same CATV network. Hence, the present invention offers a flexible, effective, economic, and fully integrated multimedia bearer system granting immediate support for Internet services, traditional voice telephony, and digital video services over a CATV network.

In U.S. Pat. No. 5,963,719 there is disclosed an intermodule network bus architecture using only two bus wires to transmit data and module state information. A two-pin bus interface in each network module connected to the bus provides for a distributed arbitration procedure in the event that two or more modules are competing for bus access, and provides a coding scheme under which both data signals and collision announcements are transmitted from module to module through the two-wire bus. The architecture handles multiple distributed repeater modules, as well as other network components such as bridges and routers connected to the same bus. An important aspect of the invention is that multiple bus interfaces function as a distributed state machine, to handle the arbitration process and to provide a consistent framework for detecting and processing data signals and various types of collisions, including receive collisions detected on a single local module port, and transmit collisions involving activity on multiple local ports of one or more modules.

Thus, as can be seen from a review of the above-cited prior art, many attempts and systems have been developed for LAN bridging or LAN distribution, but none have provided a method and system for distributed LAN bridging. Thus there is a continuing need to provide a method and system for distributed LAN bridging of data.

### III. OBJECTIVES OF THE INVENTION

It is, therefore, an objective of this invention to provide a novel LAN bridging system which overcomes the deficiencies of the prior art.

Another objective of this invention is to provide a novel distributed bridge LAN system which allows the bridged networks to be located virtually anywhere.

Yet another objective of this invention is to provide a novel distributed bridged LAN system which allows a private network to operate over another public network such as the Internet by employing encapsulation of private data sent over public IP networks.

Still another objective of this invention is to provide a novel system to connect two LANs over an arbitrary network.

Yet again, another objective of this invention is to provide a novel system wherein data from one LAN is encapsulated, transmitted to a destination network, de-encapsulated, and transmitted to another LAN.

Still another objective of this invention is to deploy an arbitrary network, (e.g., a WAN) having connectivity to a multiplicity of encapsulating devices which in turn have connectivity to their respective LANs.

### IV. SUMMARY OF THE INVENTION

These and other objectives of the instant invention are accomplished generally speaking by providing a distributed local area network (LAN) bridging system and method for use with an IP network. More particularly, the present invention preferably provides for a method and system for distributed LAN bridging in a public DVB-RCS satellite based network that interconnects private LANs by way of the public DVB-RCS satellite based network. This allows data from private networks to be transmitted between source and destination computers that do not have globally unique IP addresses. Thus, the present invention integrates private and public networks on the same IP network infrastructure. Using a satellite based DVB-RCS network allows for leveraging of the broadcast nature of satellites. A multicast program, for instance, may be transmitted to any number of destinations simultaneously.

An exemplary embodiment of the system includes a wide area network (WAN), or public network, such as the Internet, and which preferably comprises a satellite-based DVB-RCS network. A plurality of local area networks (LANs) are connected to the WAN. One of the LANs, a source LAN, is coupled by way of a data encapsulating device to the WAN. A source computer (or capturing device) is coupled to the source LAN. The source computer is used to capture data for transmission to a destination computer. The data encapsulating device is used to encapsulate data derived from the source computer (or capturing device) and transmitted over the source LAN.

Another one of the LANs, a destination LAN, is coupled by way of a de-encapsulating device to the WAN. A destination computer is coupled to the destination LAN, which in this exemplary embodiment, is to receive data transmitted from the source computer. The de-encapsulating device is used to de-encapsulate data derived from the source LAN that is transmitted over the WAN (or satellite-based network). Software runs on the system that is operative to generate or capture data (at the source computer), encapsulate the data, transport the encapsulated data to the destination LAN by way of the WAN (or satellite-based network), de-encapsulate the encapsulated data to provide de-encapsulated data, transmit the de-encapsulated data to the destination LAN, and transmit the de-encapsulated data to the destination computer.

Thus, the distributed LAN bridging system and method captures and encapsulates private LAN traffic (data), transports this traffic by way of a public WAN (such as a DVB-RCS satellite based network), de-encapsulates and transmits the de-encapsulated traffic to the second private LAN, and delivers the data to a destination computer coupled to the second private LAN. In accordance with the present invention, the private LANs are connectable at any point in the IP network to the public WAN.

### V. BRIEF DESCRIPTION OF THE DRAWINGS

The inventive system and method of the instant invention may be more fully understood with reference to the accompanying drawings in which:

FIG. 1 depicts an exemplary system in accordance with the instant invention; and

FIG. 2 is a flow diagram that depicts an exemplary process or method in accordance with the instant invention.

### VI. DETAILED DESCRIPTION

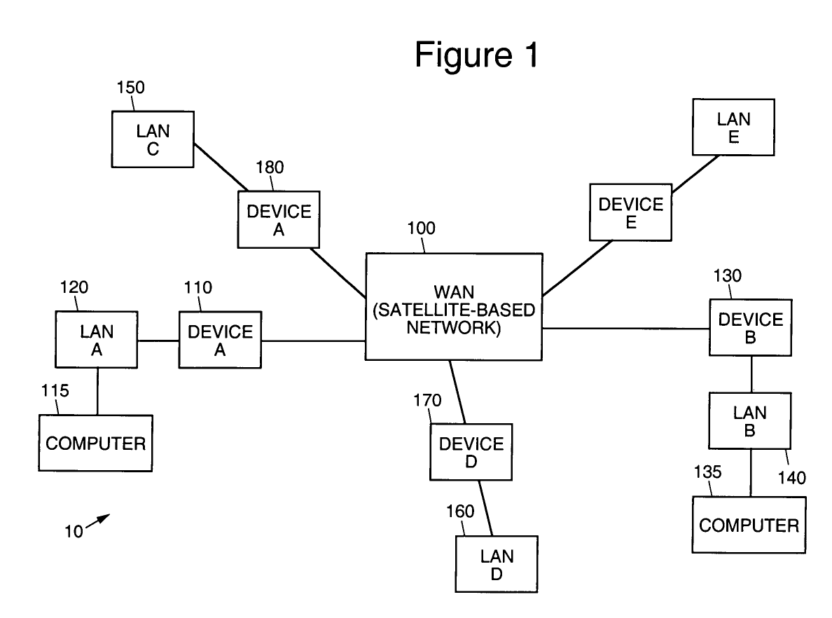

Referring to the drawing figures, FIG. 1 depicts an exemplary system (10) in accordance with the instant invention. In FIG. 1 there is seen a WAN (100) which is coupled in one instance to an encapsulating device A (110) connected to a first LAN A (120), which is typically a private LAN. The WAN (100) is also connected to a de-encapsulating device B (130) which is likewise connected to a second LAN B (140), which is typically a private LAN. A first user computer (115), or capturing device (115), is coupled to the first LAN A (120), and a second user computer (135) is coupled to the second LAN B (140). In the present system (10), the first and second user computers (115, 135) have the same IP addresses in the respective LANs (120, 140).

Any suitable encapsulating and de-encapsulating systems or devices (110, 130) may be employed in the system (10) of the instant invention. Typical encapsulating and de-encapsulating systems or devices (130), such as those discussed in the background section, may be adapted for use in the present system (10). In general, as is generally well-known in the art, encapsulation of the captured data involves addition of a header (and CRC data) to the captured data. Furthermore, during encapsulation, the data may be encrypted and/or compressed.

It may be seen that this method of connecting two LANs—LAN A (120) and LAN B (140)—may be repeated to connect a third LAN C (150) to a fourth LAN D (160) using an encapsulating device C (180) and de-encapsulating device D (170) respectively coupled between the third LAN C (150) and fourth LAN D (160) and the WAN (100), and so on. Thus, there is provided the connection of an arbitrary number of LANs (N), one to the other, over an arbitrary network or WAN (100), which provides for distribution of data in any fashion desired.

It is to be understood that the source computer (115) may be located on any one of the LAN (120, 140, 150, 160), and that the destination computer (135) may be located on any LAN (120, 140, 150, 160) that the source computer (115) is not connected to. Accordingly, the present invention is not limited to the specific system illustrated in FIG. 1.

The WAN (100) may be a public IP network such at the Internet. The respective LANs (120, 150, 150, 160) are typically private networks. The present invention is preferably employed with a satellite based network 100 that uses a DVB-RCS (digital video broadcasting-return channel via satellite) topology. This topology comprises a transmission data pipe that allows transmission of data from one site to many receivers, and a return data pipe that is shared by many receivers and which transmits data from the many receivers to the one site. This is generally referred to as a hub-spoke topology, which is illustrated in FIG. 1. The present invention fully integrates public and private network environments in the context of DVB-RCS by using encapsulation of the private data and sending it through the otherwise public IP network (WAN).

To be as transparent to users as possible, and to not require interactive support for user-specific configurations, the present invention uses the encapsulating device, such as encapsulating device A (110), to bridge Ethernet traffic (IP data) across the user LANs (i.e., first, through fourth LANs (120, 140, 150, 160), and so forth). Using the Internet (or any other arbitrary IP network), allows for the bridge network to be located virtually anywhere. The present communications protocol allows the devices (110, 130) to dynamically learn of one another and distribute the task of bridging the various networks (120, 140) among themselves.

In the case of a satellite-based network (100) that employs a DVB-RCS protocol and allows simultaneous distribution of data from one site (a source LAN (120)) to multiple geographically diverse private sites (i.e., private destination LANs (140, 150, 160)), the present invention allows the data to be “multicast” to the geographically diverse sites. The beauty of the present invention is that it allows source computers (115) coupled to a source LAN (first LAN A (100)) to have the same IP addresses as destination computers (135) coupled to any of the geographically diverse private destination LANs (140, 150, 160).

For example, data for transmission may be generated at a source computer (115) coupled to the first LAN A (120). The data includes the IP address of the source computer (115), the IP address of its encapsulating device A (110), and the IP address of the destination computer (135).

This data is transmitted over the first LAN A (100) to its encapsulating device A (110). The encapsulating device A (110) encapsulates the data transmitted from the source computer (115), by adding a header to the data that includes the IP address of the source computer (115) and the IP address of the destination computer (135). The encapsulating device A (110) transmits the encapsulated data over the WAN (100), which may comprise the satellite-based network employing the DVB-RCS protocol.

The destination de-encapsulating device (such as de-encapsulating device B (130)) knows the IP addresses of computers (135) that are coupled to the second LAN B (140). When the destination de-encapsulating device (de-encapsulating device B (130)) receives the transmitted data, it de-encapsulates the data and routes the data across the second LAN B (140) to the destination computer (135).

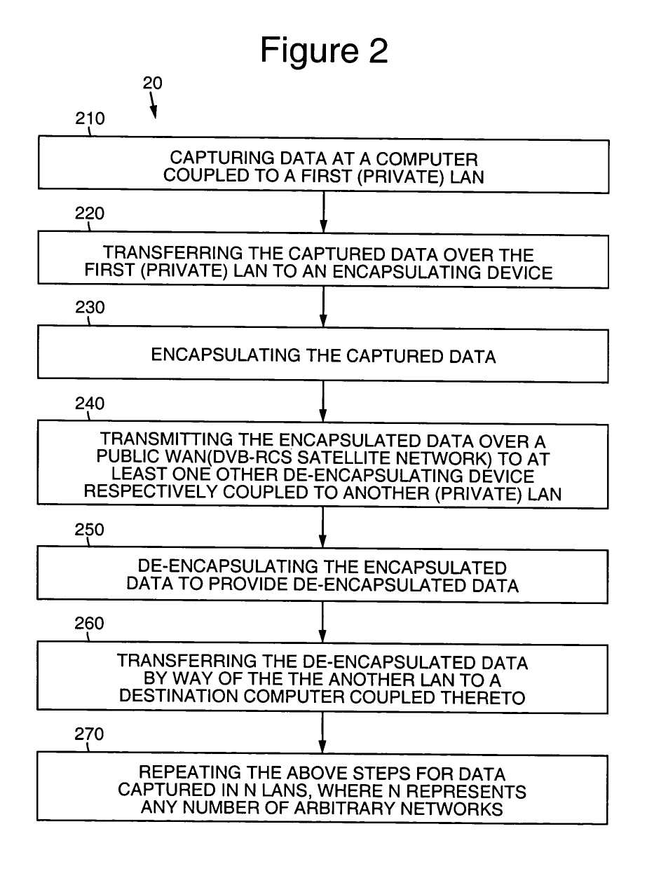

With reference to FIG. 2, it is a flow diagram that illustrates an exemplary method (20) or process (20) for distributing data within the system (10) shown in FIG. 1. The exemplary method (20) provides for a distributed LAN bridging process (20) that comprises capturing (210) data at a computer coupled to a first LAN (such as a private LAN), transferring (220) the captured data over the first (private) LAN to an encapsulating device, and encapsulating (230) the captured data. The encapsulated data is transmitted (240) over a public WAN, which may comprise a DVB-RCS satellite network, to at least one other de-encapsulating device respectively coupled to another LAN (such as a private LAN). The encapsulated data is de-encapsulated (250) to provide de-encapsulated data. The de-encapsulated data is transferred (260) by way of the another (private) LAN to a destination computer coupled thereto. The above steps may be repeated (270) for data captured in N LANs, where N represents any number of arbitrary local area networks.

While the present invention specifically describes with respect to a preferred sequence of process steps and apparatus elements in the preferred embodiments, it is to be understood that the invention is not limited to only these particular methods and apparatus described in preferred embodiments, nor to the particular process steps, sequences, or process steps, or to the various structures depicted in the drawings. On the contrary, the teaching in this invention is intended to cover all alternatives, modifications and equivalents as may be included within the spirit and scope of the invention defined by the claims which follow.

It is to be understood that the described embodiments are merely illustrative of some of the many specific embodiments that represent applications of the principles of the present invention. The scope of the invention is intended to include, for example, variations and alternatives to the disclosed devices and methods for achieving distributed LAN bridging. Clearly, numerous and other arrangements can be readily devised by those skilled in the art without departing from the scope of the invention.

1. A distributed LAN bridging process comprising:
a) capturing data at a computer coupled to a first local area network (LAN);
b) transferring the captured data over the first LAN;
c) encapsulating the captured data;
d) transporting the encapsulated data over a public wide area network (WAN);
e) de-encapsulating the encapsulated data using a de-encapsulating device coupled to a second LAN; and
f) transmitting the de-encapsulated data to a destination computer coupled to the second LAN.

2. The distributed LAN bridging process recited in claim 1 further comprising:
repeating steps a-f for data captured in N LANs, where N represents any number of arbitrary networks.

3. The distributed LAN bridging process recited in claim 1 wherein the local area networks comprise private networks.

4. The distributed LAN bridging process recited in claim 1 wherein the WAN comprises a DVB-RCS satellite network.

5. A LAN bridging system comprising:
a public wide area network (WAN);
a source local area network (LAN);
an encapsulating device coupling the source LAN to the public WAN for encapsulating data derived from the source LAN;
a destination local area network (LAN);
a de-encapsulating device coupling the destination LAN to the public WAN for de-encapsulating data derived from the source LAN; and
software that runs on the system that is operative to capture source LAN data, encapsulate the source LAN data, transport the encapsulated source LAN data over the public WAN, de-encapsulate the encapsulated source LAN data to provide de-encapsulated source LAN data, and transmit the de-encapsulated source LAN data to the destination LAN.

6. The LAN bridging system recited in claim 5 wherein the source and destination local area networks comprise private networks.

7. The LAN bridging system recited in claim 5 wherein the WAN comprises a the DVB-RCS satellite network.

8. A LAN bridging system comprising:
a public DVB-RCS satellite network;
a private source local area network (LAN);
a source computer coupled to the private source LAN;
an encapsulating device coupling the private source LAN to the public DVB-RCS satellite network for encapsulating data derived from the source computer;
a private destination local area network (LAN);
a destination computer coupled to the private destination LAN;
a de-encapsulating device coupling the private destination LAN to the public DVB-RCS satellite network for de-encapsulating data generated by the source computer and for transmitting the de-encapsulated data to the destination computer; and
software that runs on the system that is operative to capture data at the source computer, transfer captured data to the private source LAN, encapsulate the captured data, transport the encapsulated data by way of the public DVB-RCS satellite network to the de-encapsulating device, de-encapsulate the encapsulated data, and transfer the de-encapsulated data to the destination computer by way of the private destination LAN.
